(19) United States
(12) Patent Application Publication
(10) Pub. No.: US 2007/0201714 A1
(43) Pub. Date: Aug. 30, 2007

(54) Book structure with an audio generator

(76) Inventor: Chang-Fa Lee, Taipei (TW)

Correspondence Address: BACON & THOMAS, PLLC, 625 SLATERS LANE, FOURTH FLOOR, ALEXANDRIA, VA, 22314, US

(21) Appl. No.: 11/362,076

(22) Filed: Feb. 27, 2006

(51) Int. Cl. H04R 1/02; H04R 9/06

(52) U.S. Cl. 381/334; 381/124

(57) ABSTRACT

A book structure with an audio generator includes a main body in the form of a book having a plurality of book leaves with printed texts or figures, a book cover covered at the periphery of the book leaves and having a cavity, and the cavity having a controlling member connected to a loudspeaker, and the controlling member is connected to a connecting member of the book cover, such that when the book structure is used, an electronic device transfer an audio file to a memory through the connecting member, and the cavity produce a resonance, so that the audio file can be played from the loudspeaker like a speaker box. The invention requires no external electronic device for the playback, and it can save any content in the format of an audio file into the controlling member as needed.

### BACKGROUND OF THE INVENTION

1. Field of the Invention

The present invention relates to a book structure with an audio generator, and more particularly to a book that includes a cavity on a book cover, so that a loudspeaker installed in the cavity can produce a resonance with the cavity to play a prerecorded sound.

2. Description of the Related Art

Most publications including books emphasize on good pictures and text contents, but readers only can read the publications or books quietly, and reading of this kind may be boring to children or adult readers.

In general, an audio book is stored in an optical disk or another storage device in the format of a computer file, and when a user wants to read the audio book, the user has to use an external electronic device such as a computer or a digital personal assistant to play the audio book, making the reading of an audio book inconvenient.

To overcome the foregoing shortcomings of the audio books, a specially made book is combined with a voice generating means, and the voice generating means includes a detecting means for identifying each page of the book, so that when a reader turns a certain page of the book, the voice generating means can produce a specific voice message of the page, or the audio book installs a press button at a place where a voice is needed, so that a user can press the press button to play the intended voice or sound. Such method is commonly used for teaching children languages, but the aforementioned audio books prerecord intended voices or sounds in the book, and thus making children unable to hear their parents' voice while reading the audio book. For people who send an audio book to their friend, the recipient cannot hear the sender's tender voice or wonderful music, and an audio book is simply a book having sounds in addition to the texts or figures. The audio books cannot timely express a user's mood while reading the audio books and also cannot change the audio content according to the reader's needs, and thus the prior art audio books still require further improvements.

### SUMMARY OF THE INVENTION

In view of the foregoing shortcomings of the prior art, the inventor of the present invention based on years of experience in the related industry to conduct extensive researches and experiments to find a feasible solution to overcome the shortcomings, and finally invented a book structure with an audio generator in accordance with the present invention.

Therefore, it is a primary objective of the present invention to provide a book structure with an audio generator, and the structure includes a main body, and the main body includes a plurality of book leaves with printed texts or figures, and the periphery of the book leaves is wrapped by a book cover, and the book cover includes a cavity, and the cavity includes a controlling member connected to a loudspeaker and a memory, and the controlling member is connected to a connecting member at a surface of the book cover, such that when the book structure is in use, an electronic device can be connected to the controlling member of the main body through the connecting member, and an audio file including background music, reading comments, or description of text contents is recorded by a recording program according to a user's need. The audio file is saved in the format of an audio file into the memory, so that the controlling member can be controlled to play the audio file in the memory through the loudspeaker. While the audio file is played, the cavity produces a resonance so as to play the audio file clearly without using another external audio device.

Another objective of the present invention is to provide a book structure with an audio generator, wherein the book cover includes an audio connector connected to the controlling member, so that when users carry the book structure out with them, an external electronic device can be connected to the audio connector and the controlling member, so that the loudspeaker and cavity of the present invention can act as a speaker box to play music or voice on the external electronic device. The book structure is convenient to carry and easy to operate.

A further objective of the present invention is to provide a book structure with an audio generator, wherein the controlling member can be connected to a manually operated switch or a press switch, so that users can turn on the controlling member manually or by opening the book cover to play the audio file from the loudspeaker.

### BRIEF DESCRIPTION OF THE DRAWINGS

FIG. 1 is a schematic perspective view of the present invention;

FIG. 2 is another schematic perspective view of the present invention;

FIG. 2a is an enlarged perspective view of a portion of the present invention;

FIG. 3 is a cross-sectional view of a preferred embodiment of the present invention;

FIG. 4 is a cross-sectional view of another preferred embodiment of the present invention; and

FIG. 5 is a schematic view of connecting an external electronic device according to the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

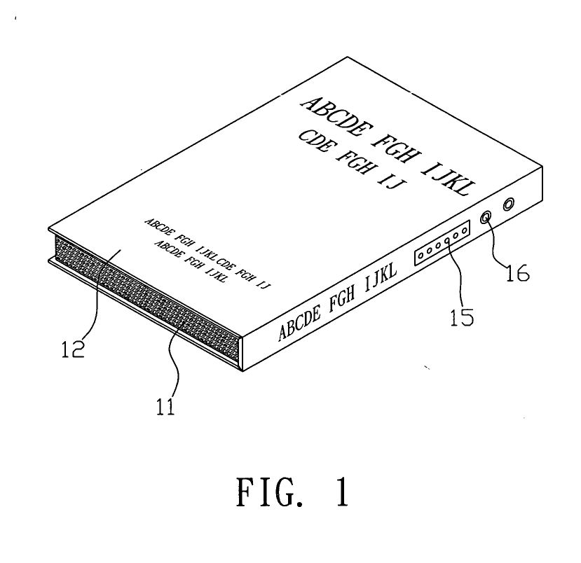

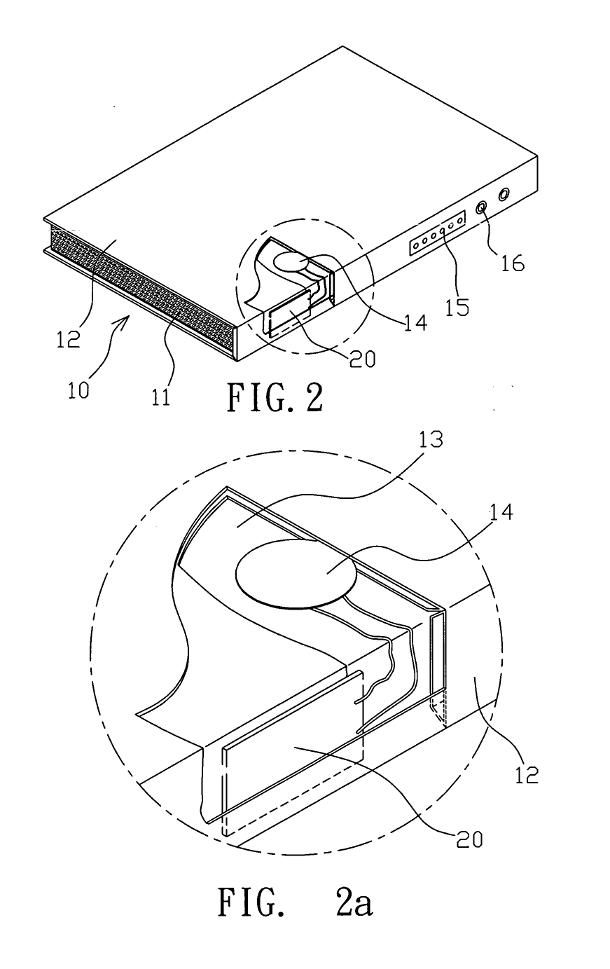

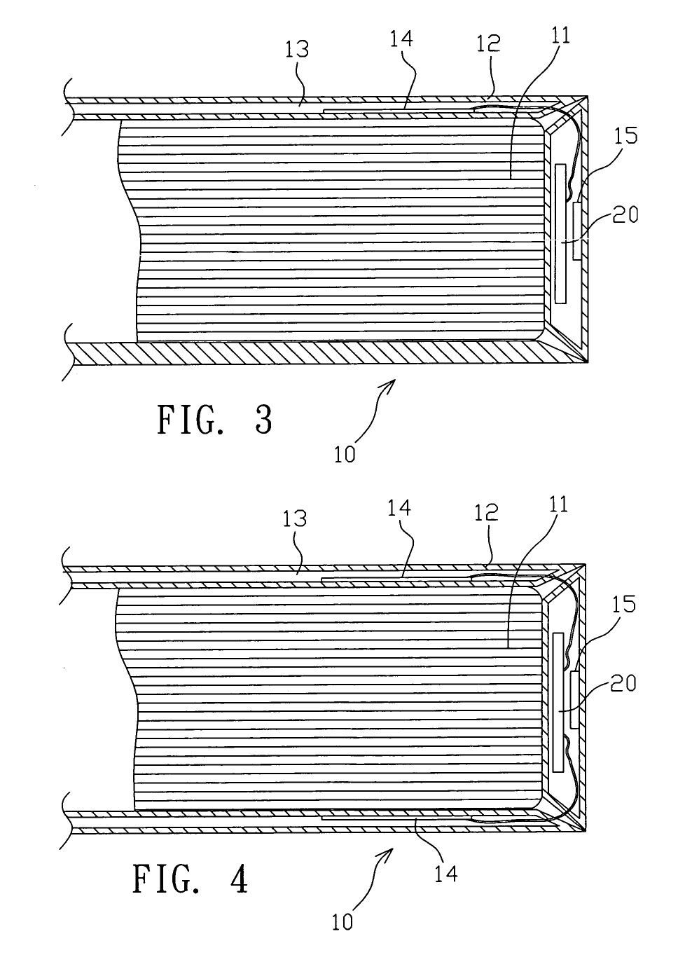

Referring to FIGS. 1, 2 and 2a for the book structure with an audio generator in accordance with the present invention, the book structure includes a main body 10 which is made in the form of a book, and the main body 10 includes a plurality of book leaves 11 printed with texts or figures for users to read statically, and a book cover 12 wrapped on the surface of the book leaves 11 and connected to both sides of the book leaves 11, and the book cover 12 includes a cavity 13, and the cavity 13 includes a controlling member 20 which is a circuit board in this preferred embodiment, but it also could be a chip. The controlling member 20 includes a processor and a memory (not shown in the figure), and the cavity 13 includes a loudspeaker 14 disposed on one side or both sides of the cavity 13 (as shown in FIGS. 3 and 4) and connected to the controlling member 20.

Further, the book cover 12 includes a connecting member 15 (which is a socket in this preferred embodiment) and an audio connector 16 disposed on a side of the book cover 12, and the connecting member 15 and the audio connector 16 are electrically connected to the controlling member 20, and the controlling member 20 is electrically connected to a switch (not shown in the figure). The switch could be a manually operated switch or a press switch that can turn on or off the controlling member 20.

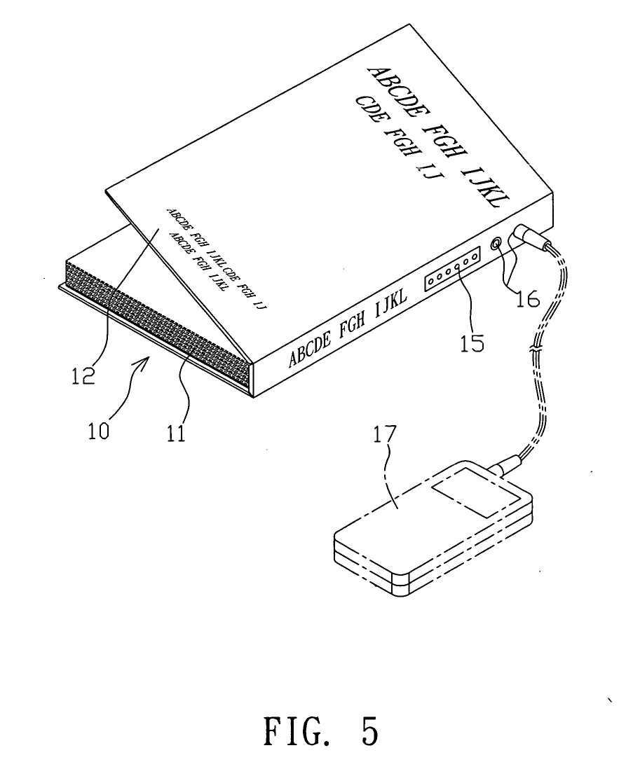

Referring to FIGS. 2 to 5, an external electronic device 17 (such as a computer or a personal digital assistant) can be connected to the controlling member 20 in the main body 10 through the connecting member 15, and an audio file such as music, comment, textual description, or promotion wording is recorded by a recording program according to a user's need and saved into the memory in an audio format, such that the controlling member 20 can be controlled to play the audio file in the memory through the loudspeaker 14. While the audio file is being played, the cavity 13 produces a resonance to play the audio file clearly without using another audio device. When users bring the book structure out with them, the external electronic device 17 is connected to the controlling member 20 through the audio connector 16, and the loudspeaker 14 and the cavity 13 of the present invention are similar to a speaker box for playing music or sound from the electronic device. The book structure of the invention is easy to carry and simple to operate.

In summation of the description above, the book structure with an audio generator of the invention comes with a simple overall structure, which can be used in any configuration to enhance its utility, and thus the invention complies with the patent application requirements.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A book structure with an audio generator, comprising:
a main body, made in the form of a book;
a book cover, being covered onto the surfaces of said main body and having a cavity;
a controlling member, installed in said cavity;
a loudspeaker, installed in said cavity and coupled to said controlling member; and
a connecting member, installed on a surface of said book cover and coupled to said controlling member, and said connecting member having a memory;
such that when said book structure is used, an external electronic device is connected to said controlling member in said main body through said connecting member, and an audio file is recorded according to a user's need and saved in the format of an audio file into said memory, so that said controlling member is controlled to play said audio file through said loudspeaker, and produce a resonance with said cavity, such that a voice or a sound can be played to the outside clearly without using another external audio device.

2. The book structure with an audio generator of claim 1, wherein said book cover includes an audio connector disposed at a surface of said book cover.

3. The book structure with an audio generator of claim 1, wherein said controlling member is a circuit board or a chip.

4. The book structure with an audio generator of claim 1, wherein said loudspeaker is installed on one side of said book cover or separately both sides of said book cover.
